(19) United States
(12) Patent Application Publication
(10) Pub. No.: US 2006/0285914 A1
(43) Pub. Date: Dec. 21, 2006

(54) Notebook accessory product having dry erase functionality

(76) Inventors: Andrew T. Bassford, Sunnyvale, CA (US); Nitin D. Gupta, Pleasanton, CA (US); Katie I. Hatsushi, Danville, CA (US)

Correspondence Address: McCARTER & English, LLP;Financial Centre, Suite 304A, 695 East Main Street, Stamford, CT, 06901-2138, US

(21) Appl. No.: 11/407,628

(22) Filed: Apr. 20, 2006

Related U.S. Application Data
(63) Continuation of application No. 11/059,495, filed on Feb. 16, 2005.
(60) Provisional application No. 60/545,748, filed on Feb. 18, 2004.

(51) Int. Cl. B42F 13/00

(52) U.S. Cl. 402/79

(57) ABSTRACT

An accessory stationery product is provided that includes at least one dry erase board surface that is adapted to be detachably mounted within or with respect to a spiral bound notebook. The accessory product includes structural feature(s) that allow a user to insert the dry erase surface into engagement with wire binder of a spiral bound notebook. The inserts are compatible with a range of standard/conventional spiral bound notebooks, i.e., spiral bound notebooks manufactured by various manufacturers and offered under various brand names. The accessory device addresses fundamental shortcomings associated with conventional spiral bound notebook design/use by giving users a cleanly erasable and reusable work space for notes and scratch work within the spiral bound notebook, thereby permitting the user to save paper and stay organized. Thus, the accessory device allows the user to have two spaces within a notebook: a versatile, dry erase space for temporary notes and scratch work and the rest of the notebook for more permanent work.

### 1. CROSS-REFERENCE TO RELATED APPLICATIONS

The present application is a continuation application that claims the benefit of a co-pending, commonly owned non-provisional patent application entitled “Notebook Accessory Product Having Dry Erase Functionality,” which was filed on Feb. 16, 2005 and assigned Ser. No. 11/059,495, which claimed priority to a provisional patent application entitled “Notebook Accessory Product That Includes Dry Erase Board Functionality,” which was filed on Feb. 18, 2004 and assigned Ser. No. 60/545,748. The entire contents of the foregoing non-provisional and provisional patent applications are incorporated herein by reference.

### BACKGROUND

1. Technical Field

The present disclosure is directed to an accessory product that is adapted for use with a spiral bound notebook and that increases efficiency and minimizes paper use associated therewith. More particularly, the present disclosure is directed to an accessory product that includes structural feature(s) that permit detachable mounting with respect to a spiral bound notebook and at least one dry erase surface for positioning within such spiral bound notebook.

2. Background Art

Notebooks are routinely used for collecting, organizing and retaining information, e.g., notes and work product. Although notebooks come in numerous types, styles and sizes, two commonplace types of notebooks are “three-ring binders” and “spiral bound” notebooks. In the case of three-ring binders, pages and/or dividers may be inserted/removed on an as-needed basis by “opening” and “closing” the three rings. Materials introduced to the three-ring binder generally include spaced holes along the left margin that correspond to the spacing of the three rings. Many three-ring binders also include flaps in the front and/or back face thereof for storing loose papers or other items. Thus, three-ring binders generally offer a measure of flexibility to users by permitting unlimited introduction and removal of papers with respect thereto.

Unlike three-ring binders, spiral bound notebooks do not generally permit the user to introduce loose papers or other items into the notebook. Rather, the spiral bound notebook generally defines an integral unit from which papers may be removed, but to which papers cannot be effectively added. Moreover, unlike three-ring binders, spiral bound notebooks do not permit users to re-order the contents thereof. Thus, for example, if a user makes a history-related note in a section of a spiral bound notebook that relates to math, it is not possible to relocate such note to the math portion of the notebook or conveniently view such note while working in the math portion of the notebook (unless the note is permanently detached from the spiral bound notebook).

Prior art efforts have been devoted to addressing some of the foregoing issues associate with spiral bound notebooks. For example, U.S. Pat. No. 4,430,015 to Nerlinger, U.S. Pat. No. 6,390,713 to Moor et al., and U.S. Pat. No. 6,672,785 to O'Hara et al. disclose structural features that permit a document or other item to be detachably fastened to a spiral bound notebook. Each of the foregoing U.S. patents is incorporated herein by reference.

Despite efforts to date, a substantial need remains for a product and/or system that permits a spiral bound notebook user to take notes, do scratch work or the like in an efficient and less wasteful manner. Typically, spiral bound notebooks have been used for both note-taking and scratch work, leading to excessive paper waste and disorganization of notes. There is a further need for an accessory product that may be detachably associated with a spiral bound notebook and that facilitates easy and reliable erasure and re-use.

These and other needs are met by the accessory product and associated systems disclosed herein. Additional features and functionalities associated with the disclosed accessory product and associated systems will be apparent to persons of ordinary skill in the art from the detailed description and associated figures provided below.

### SUMMARY OF THE DISCLOSURE

The accessory product of the present disclosure includes at least one dry erase board surface that is adapted to be detachably mounted within or with respect to a spiral bound notebook. According to exemplary embodiments of the present disclosure, the disclosed accessory product includes structural feature(s) that allow a user to insert the dry erase surface into engagement with wire binder of a spiral bound notebook. Exemplary embodiments of the present disclosure are compatible with a range of standard/conventional spiral bound notebooks, i.e., spiral bound notebooks manufactured by various manufacturers and offered under various brand names. The accessory device of the present disclosure addresses fundamental shortcomings associated with conventional spiral bound notebook design and use by giving users a cleanly erasable and reusable work space for notes and scratch work within the spiral bound notebook, thereby permitting the user to save paper and stay organized. Thus, the present disclosure allows the user to have two spaces within a notebook: a versatile, dry erase space for temporary notes and scratch work and the rest of the notebook for more permanent work.

In exemplary embodiments of the present disclosure, the product/system is the approximate length and width of a standard spiral-bound notebook, and is the depth of about three sheets of printer paper. The product may be folded in two, with a secondary fold to allow flexibility. The outer side of the product is made of a plastic-based dry erase surface. In order to insert the product, there are structural features, e.g., three small (˜½″) nubs on one end, that will slip between the rings of the spiral bounding of most standard notebooks.

The accessory product (and associated system) of the present disclosure is particularly adapted for use by students, researchers and other individuals that are involved in or called upon to record, retain and/or organize written information. Individuals that may be particularly benefited by the design, operation and use of the disclosed accessory product are high school and college students, especially those in analytical classes such as the sciences, medicine/dentistry, accounting/finance, mathematics and computer science/programming. Users of the disclosed product/system advantageously reduce waste and enhance notebook use efficiency.

### BRIEF DESCRIPTION OF FIGURES

To assist those of ordinary skill in the art in making and using the disclosed notebook accessory products, reference is made to the accompanying figures, wherein:

FIG. 1 is a perspective view of an exemplary notebook accessory product according to the present disclosure;

FIG. 2 is a plan view of the exemplary notebook accessory product of FIG. 1; and

FIGS. 3-5 are cut-away views of exemplary notebook-cooperating mechanisms according to the present disclosure.

### DESCRIPTION OF EXEMPLARY EMBODIMENT(S)

According to the present disclosure, accessory products and systems are provided that include at least one dry erase board surface that is adapted to be detachably mounted within or with respect to a spiral bound notebook. The disclosed accessory product includes structural feature(s) that allow a user to insert the dry erase surface into engagement with wire binder of a spiral bound notebook. The products/systems advantageously give users a cleanly erasable and reusable work space for notes and scratch work within the spiral bound notebook, thereby permitting the user to save paper and stay organized.

Exemplary embodiments of the present disclosure are compatible with a range of standard/conventional spiral bound notebooks, i.e., spiral bound notebooks manufactured by various manufacturers and offered under various brand names. According to exemplary embodiments of the present disclosure, the product/system functions as an add-on or accessory for a spiral bound notebook that increases efficiency and minimizes paper use, although it is contemplated that the disclosed product/system may be offered as part of a package and/or kit that includes one or more spiral bound notebooks, i.e., as an integrated product offering.

Additional product attributes associated with exemplary embodiments of the disclosed accessory product and associated system include:
1- Lightweight—less than 1 pound
2- Durable—can withstand extended use, e.g., multiple semesters of student use
3- Affordable—low cost manufacture
4- Can be transferred from spiral bound notebook to spiral bound notebook
5- Functions as a page marker
6- Fits multiple notebook brands
7- Does not waste excessive paper for scratch calculations
8- Easy to use for both left and right handed people
9- Water resistant
10- Aesthetically pleasing
11- Easy erase mechanism
12- Includes place and/or structure to hold/store writing utensil(s) and/or other stationery items
13- Has place and/or structure to hold/store loose sheets of paper or other elongated supplies
14- Environmentally friendly
15- Smear-proof pages
16- No build-up left in spiral bound notebook(s) after removing the product/system

As noted previously, the disclosed product/system has wide ranging uses and applications. Primary users of the disclosed product/system may include college science and engineering students, MBA and graduate science school students, and high school and middle school students, although uses/applications certainly extend to a full range of students and other consumers, including liberal arts college students, elementary school students, and individuals that are active in the private sector.

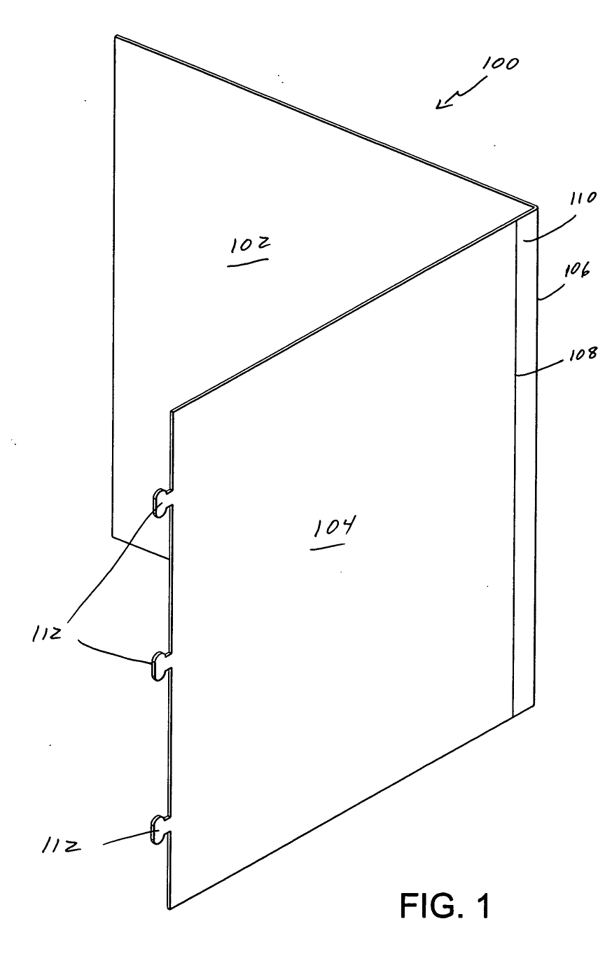

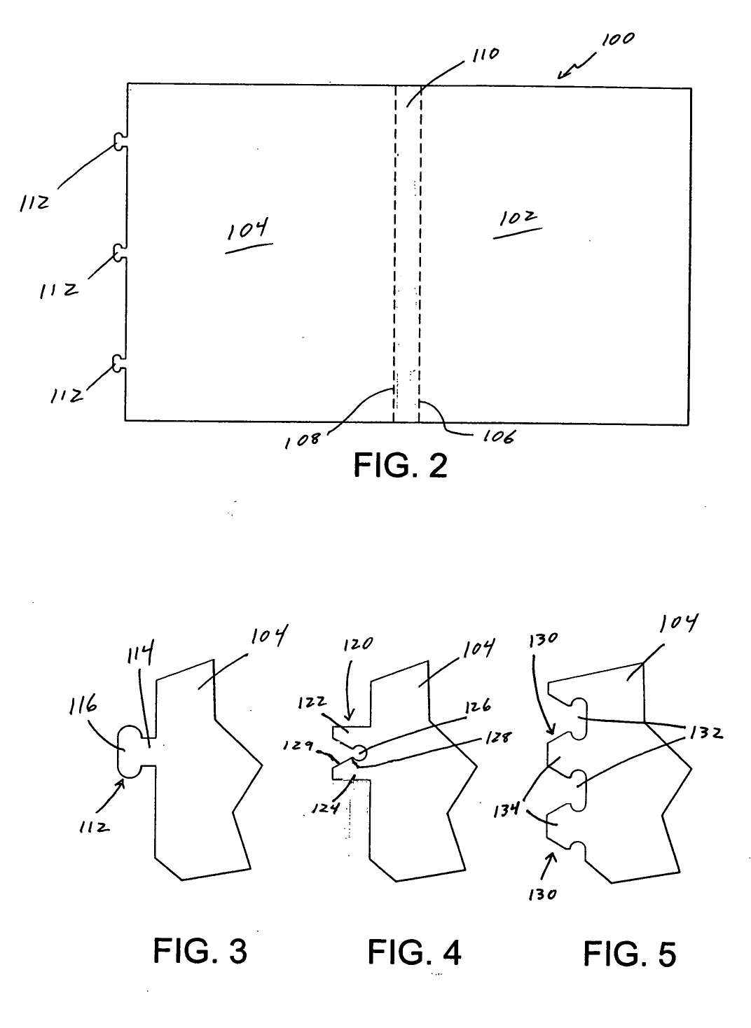

To further illustrate exemplary embodiments of the present disclosure, reference is made to the accompanying figures and the associated narrative description set forth below. With initial reference to FIGS. 1 and 2, an exemplary product insert 100 according to the present disclosure includes a first face 102 and a second face 104 that fold with respect to each other relative to first fold line 106 and second fold line 108. A spine region 110 is defined between the first and second fold lines 106, 108 such that, when the first and second faces 102, 104 are brought into (or toward) an overlying relation, a volume of paper or other material may be easily accommodated therebetween. The width of the spine 110 is generally determined based on the spacing between the first and second fold lines 106, 108. Such spacing may be varied based on the desired volume of paper/materials to be accommodated between the first/second faces 102, 104, as will be apparent to persons skilled in the art. Of note, the tri-fold arrangement of the disclosed insert offers a user numerous advantages, including (i) stabilizing the insert 100 within a spiral bound notebook, (ii) organizing materials within a spiral bound notebook, (iii) marking a page/region within the spiral bound notebook for ready access, and (iv) permitting easy expansion of the dry erase writing surface.

With further reference to FIGS. 1 and 2, it is noted that structural features that accommodate detachable attachment to a spiral bound notebook are associated with only one of the two faces (such face shall be referred to as the “second face”). In the schematically depicted embodiment, the structural features for facilitating detachable attachment to a spiral bound notebook take the form of three outwardly extending, spaced T-shaped nubs 112. As noted herein below, the present disclosure is not limited to this specific T-shaped geometry; rather, a variety of structural arrangements are contemplated and may be employed to facilitate the desired interaction between the spiral bound notebook and the disclosed insert 100. In the disclosed embodiment, the outwardly extending nubs 112 are advantageously aligned with the hole punches associated with a conventional three-ring binder (not pictured), thereby providing top-to-bottom stability to the disclosed insert 100 when mounted to a spiral bound notebook.

According to exemplary embodiments of the present disclosure, a dry erase surface is defined on at least one side of the first and second faces 102, 104 of the disclosed insert 100. Conventional dry erase materials and fabrication techniques are employed in connection with defining such dry erase surfaces. Thus, in embodiments wherein a dry erase surface is only defined on one of the two sides, such side will be the outwardly directed side when the front and back faces 102, 104 are folded relative to the fold lines 106, 108. In this way, the folded structure will define a first dry erase face and a second dry erase face, each of which is accessible for note-taking, scratch work and the like when the insert is detachably mounted with respect to a spiral bound notebook. In addition, a user is free to “open up” the tri-fold structure so as to expose the “first face” (i.e., the face not associated with mounting relative to the notebook) beyond the boundary of the spiral bound notebook, so as to provide additional (and potentially more accessible) dry erase surface for note-taking, scratch work and the like.

While the embodiment schematically depicted hereinabove shows first and second faces 102, 104 that are substantially rectangular in geometry, the present disclosure is not limited to such geometric arrangement. Rather, the first and/or second faces may feature alternative geometric configurations, such as triangular shapes, trapezoidal shapes, arcuately-shaped edge surfaces, and the like. The overall geometry of the first and/or second face 102, 104 may be larger or smaller than the size of the spiral bound notebook (e.g., 8.5″×11″) or substantially the same size as the spiral bound notebook. In the case where the first and/or second face is taller than the spiral bound notebook, such face advantageously functions as a marker for desired location(s) within the spiral bound notebook.

The schematically depicted insert 100 of FIGS. 1 and 2 features first and second faces 102, 104 that are substantially plain (i.e., non-lined, non-printed). While it is contemplated that the first and/or second dry erase faces 102, 104 may be substantially plain and white, it is further contemplated that the first and/or second dry erase faces 102, 104 may be colored (in whole or in part) or may include printed indicia (in whole or in part), e.g., horizontal lines, graph lines, musical staff(s) and the like. It is further contemplated that reference information may be printed on the first and/or second faces 102, 104, e.g., the periodic chart, conversion tables, calendar information, and the like. Reference information may also be printed on spine 110, e.g., personal information, school information, subject information, and the like. Thus, the overall design and communicative features of the first and/or second faces 102, 104 may be varied in numerous ways without departing from the spirit or scope of the present disclosure.

Beyond the inclusion of printed indicia on the first and/or second faces 102, 104, it is further contemplated that the first and/or second faces 102, 104 may cooperate with ancillary elements that provide such printed indicia. Thus, for example, the disclosed insert 100 may be structured and dimensioned to cooperate with a graph paper template (not pictured) such that a user may associate the dry erase surfaces of the insert 100 with such template, as desired, for use therewith. In an exemplary embodiment, the template may be positioned behind or below the dry erase surface such that it is visible therethrough, thereby permitting use of the dry erase surface with printed indicia associated with such template.

As set forth in the schematic illustrations of FIGS. 1 and 2, structural feature(s) are advantageously incorporated into the product/system to facilitate detachable mounting with respect to conventional spiral bound notebooks. The structural feature(s) generally comprise spaced extensions, e.g., nubs, and/or spaced openings. In certain exemplary embodiments, the structural features facilitate mounting with respect to both conventional spiral bound notebooks and three-ring binders, thereby provided greater flexibility and utility to users.

Specifically and with reference to FIGS. 3-5, a variety of nub-insertion structures have been developed, as illustrated in the schematic depictions provided herein. Alternative structures are also contemplated, e.g., as shown in the provisional patent application incorporated herein. Thus, the present disclosure is not limited to the specific structures set forth in FIGS. 3-5 hereto. The disclosed structures have been found to be compatible with the accessory product described herein (and the functionalities associated therewith) and have also been found to be effective for insertion into notebook products, as described herein. Thus, in exemplary embodiments of the present disclosure, the accessory product/insert is effectively attached/coupled by either encompassing individual rings or hooking around multiple rings in a standard notebook or binder.

With particular reference to FIGS. 1-3, each of the nubs 112 includes an extension arm 114 and an enlarged engagement member 116. The length of extension arm 114 is generally selected to cooperate with conventional spiral rings. More particularly, extension arms 114 are sized such that engagement member 116 may be positioned within the loop of a conventional spiral ring of a spiral bound notebook. The outer edges of engagement member 116 are typically curved so as to facilitate the positioning of nub 112 relative to a spiral ring, i.e., insertion and removal of nub 112 with respect to a spiral ring. Of note, nub 112 is typically fabricated as an integral extension from second face 104, although alternative techniques may be employed without departing from the spirit or scope of the present disclosure. For example, nubs 112 may be separately fabricated and adhered/mounted with respect to the second face 104 thereafter.

With reference to FIG. 4, an alternative mounting structure, i.e., receptor 120, is schematically depicted. Receptor 120 extends from second face 104 and includes first and second side walls 122, 124 that define an internal cavity 126. The internal cavity 126 is substantially circular in geometry and a neck region 128 is formed by side walls 122, 124 to facilitate capture of a spiral wound wire therewithin. Opposed, angled entry surfaces 129 are also defined on side walls 122, 124 to guide a spiral wound wire into cavity 126. In use, receptor 120 advantageously facilitates detachable mounting of second face 104 (and therefore insert 100) relative to a spiral bound notebook by receiving spiral wound wire within cavity 126. Although neck region 128 serves to capture a wire within cavity 126, removal of the wire from cavity 126 is easily achieved, as desired by an insert user.

With reference to FIG. 5, a further exemplary mounting mechanism according to the present disclosure is schematically depicted. The exemplary mounting mechanism of FIG. 5 takes the form of a plurality of spaced, side-by-side mounting extensions 130 that define intermediate cavities 132. Mounting extensions 130 are configured and dimensioned to cooperate with a spiral wound wire associated with a conventional spiral bound notebook. According to the exemplary embodiment of FIG. 5, mounting extensions 130 have a substantially trapezoidal engagement portion 134. The side faces of the trapezoidal engagement portions function as guide surfaces for guiding a wire into an associated cavity 132. Of note, although the mounting extensions 130 shown in FIG. 5 are in substantially side-by-side relationship, it is further contemplated according to the present disclosure that mounting extensions of the geometry depicted in FIG. 5 may be spaced at greater distances along the edge of second face 104, without departing from the spirit or scope of the present disclosure.

Fabrication of products/systems incorporating the disclosed structural features may be undertaken in a variety of ways, e.g., utilizing conventional die cut techniques and/or independent fabrication of such structural features as part of a component that is subsequently joined to a planar element that features a dry erase surface, as described in greater detail below. In any event, the structural feature(s) that facilitate detachable mounting with respect to a spiral bound notebook generally exhibit sufficient rigidity to ensure reliable interaction with the spiral bound notebook, while simultaneously exhibiting a degree of flexibility/elasticity that permits the structural features to engage/disengage relative to the wire binder of the spiral bound notebook.

In use, the disclosed insert is detachably mounted with respect to a spiral bound notebook by inserting the structural features, e.g., nubs, within the wire binder of the notebook. The first face may be placed at a location within the spiral bound notebook such that a plurality of pages are confined between the first and second faces. The user may control the location of the first face within the notebook, if desired, thereby using the first face to mark a desired location. Once positioned within the spiral bound notebook, the dry erase surface(s) may be used for note-taking, scratch work and the like. Thus, for example, a user may enter or record “permanent” notes directly onto pages that are bound within the spiral bound notebook, while simultaneously recording related or unrelated notes, scratch calculations, follow-up thoughts, etc., on a dry erase surface that is in close proximity to the “permanent” note-taking location. The user is then free to relocate the disclosed insert to another location within the spiral bound notebook, to a different spiral bound notebook, and/or to an altogether different location, as desired. Significant flexibility and efficiency are achieved through use of the disclosed insert, as will be readily apparent to all notebook users and others involved in recording, retaining and/or accessing documented information.

Having generally described the overall design and operation of exemplary embodiments of the disclosed insert product/system, various advantageous features and functions associated with the disclosed insert technology are now described.

Dry Erase Surface/Page

The dry erase surface(s) of the disclosed insert product/system provide users with the advantageous ability to conveniently sketch diagrams, solve equations, and doodle and erase the work, as needed and without interfering with “permanent” recordation of information within a spiral bound notebook. This feature is desirable for notebook users, as it will be very flexible in its portability. The add-in/insert is generally foldable, functioning as a page marker with room for flexibility. For the dry erase surface/whiteboard page, a special type of pen must be used to record information, as is known to persons skilled in the art and use of dry erase products. Of note, the disclosed product/system is invertible to increase the utility and flexibility thereof.

Additional Features and Functionalities

Exemplary versions of the disclosed product/system are made of plastic to make sure the product/system is durable, portable and lightweight. Furthermore, plastic fabrication generally offers aesthetic advantages and flexibility. Plastic materials generally offer the desired rigidity/flexibility, such that the outwardly extending nubs or other structural feature(s) will fit into the standard binding of most notebooks and be easy to attach and detach. An eraser may be provided and/or used in conjunction with the disclosed insert product/system. In a preferred embodiment of the present disclosure, the eraser is fabricated from a Velcro™ material, e.g., a swatch, strip or cloth remnant, and will be available for the user to position at a place of their convenience. Of note, the disclosed insert will be flexible enough to work from both sides of the spiral bound notebook. Additional features are contemplated for inclusion as part of the disclosed accessory product, including features/functionalities having enhanced feasibility/cost justification as technology progresses. One such example would be the ability to print, download, or electronically record markings made on the whiteboard/dry erase board surface. The electronically captured image(s) could be advantageously transmitted wirelessly or via data cables to an appropriate external device, e.g., a laptop computer, PDA or the like. Such modifications and/or enhancements would allow the temporary markings on the accessory product to be stored in a permanent form, incorporated into word processing document(s), spreadsheet(s), forwarded by e-mail, or the like.

Exemplary Product Specifications

Total Length: 17.8 inches
   Nub Length: 0.37 inches
Total Width: 10.8 inches
   Nub Width: 0.56 inches
Distance between nubs:
   Top to Nub one: 1.7 inches
   Nub one to Nub two: 3.1 inches
   Nub two to Nub three: 3.4 inches
   Nub three to Bottom: 1.7 inches
Total Weight:
   15 grams
Color:
   Glossy white
Material:
   Thin, flexible whiteboard plastic
      Type of Material
A thin cardboard material with an adhesive dry erase surface applied
A plastic folder with an adhesive dry erase surface applied
A plastic sheet of poster board that included a dry erase surface
   Location of Dry Erase Surface
Include the dry erase material on all surfaces; both the exterior and interior of the notebook insert
Include the dry erase material only on the exterior surfaces
   Accessories Associated with Exemplary Embodiments of the Disclosed Product/System
Dry erase pen
Dry erase eraser
Calculator
Eraser pocket
Pen holder
Perforated ruler
Post-It® flags
Post-It® memo sheets
Plastic or cardboard folders
   Method of Notebook Insertion
Circular nubs to attach to every spiral binding
Circular nubs to attach to top, middle and bottom spiral bounds
Rounded T-shaped nubs
Three-hole punched
Circular nubs that would attach to both 3-ring binders and spiral notebooks
Variation in nub number
Variation in nub placement
   Aesthetics
Variety of colors for the notebook insert
Printed lines to simulate graph paper
Printed lines to be used as a weekly/monthly calendar
Borders/graphics
Placement of logo on product

Although the present disclosure includes a description of exemplary embodiments of the disclosed insert product/system, the present disclosure is not limited to such exemplary embodiments. Rather, the present disclosure encompasses various modifications and/or enhancements to the disclosed embodiments, as will be readily apparent to persons skilled in the art from the detailed description herein. For example, the following variations are specifically contemplated: (i) reinforcement of the structural features (e.g., nubs) to extend the life-span of the disclosed inserts (i.e., reduce risk of failure after repeated/extended use); (ii) inclusion of “pockets” or “flaps” at the top, bottom and/or side of first and/or second faces, to facilitate capture/storage of loose materials—such pockets/flaps may be fabricated from a dry erase or non-dry erase material; (iii) cooperative structure associated with first and/or second face for engaging Velcro™ material (which functions as eraser for dry erase surface); (iv) inclusion of distinct functionality on the “inner surfaces” of the first and/or second face (i.e., the side(s) opposite the dry erase surface), e.g., calendar, graph paper, tabular grids for entry of contact information, etc.; (v) provision of protective wax paper/contact paper for preservation of information recorded on the first and/or second dry erase surface—the wax paper/contact paper may be mounted with respect to the insert, e.g., as a flap or the like; (vi) an insert having the tri-fold functionality disclosed herein may be integrally associated with a spiral bound notebook when the spiral bound notebook is fabricated; (vii) a dry erase surface may be positioned relative to a window formed in the front and/or back cover of a notebook (spiral, three-ring or other), thereby permitting non-permanent entry of the subject matter to be retained within the notebook—the window may have a removable see-through cover associated therewith; (viii) the aforementioned accessory product may be configured and dimensioned to be mounted with respect to a notebook/binder by slipping the front or back cover of a notebook or binder into a “pouch” (fabricated from a suitable material and open on one lengthwise side), thereby providing a further mounting mechanism for a dry erase surface relative to such notebook/binder by encompassing and/or attaching the dry erase surface relative to the pouch structure; and (ix) an eraser for use with the dry erase surface(s) may be removably positioned within a slit formed in a folder associated with the insert and/or a notebook. These and other modifications/enhancements that may be apparent to skilled artisans based on the present disclosure are expressly included within the spirit and scope hereof.

1. A system comprising:
(a) a spiral bound notebook;
(b) an insert that is integrally mounted with respect to said spiral bound notebook, said insert including at least one dry erase surface.

2. A system according to claim 1, wherein said integrally mounted insert includes a plurality of receptors for capture of a spiral wound wire associated with spiral said spiral bound notebook.

3. A system according to claim 2, wherein each of said plurality of receptors includes an internal cavity.

4. A system according to claim 3, wherein said internal cavity is substantially circular in geometry.

5. A system according to claim 1, wherein said insert provides an erasable and reusable surface within said spiral bound notebook.

6. A system according to claim 1, wherein the at least one dry erase surface of said insert is fabricated from a plastic.

7. A system according to claim 1, further comprising a structure to hold a writing utensil.

8. A system according to claim 1, further comprising a structure to hold loose sheets of paper.

9. A system according to claim 1, wherein said insert is substantially rectangular in geometry.

10. A system according to claim 1, wherein said insert includes printed indicia.

11. A system according to claim 10, wherein said indicia is a logo.

12. A system according to claim 1, wherein said at least one dry erase surface is adapted to function with a pen specially adapted for use with said at least one dry erase surface.

13. A system according to claim 12, further comprising a pen holder and a pen that is specially adapted for use with said at least one dry erase surface.

14. A system according to claim 1, further comprising an eraser that is adapted to erase entries from said at least one dry erase surface.

15. A system according to claim 1, wherein said insert defines an interior surface and an exterior surface, and wherein a dry erase surface is defined on both said interior surface and said exterior surface.

16. A system according to claim 1, further comprising a pocket or flap associated with said insert.

17. A system according to claim 16, wherein said insert defines a top surface, a bottom surface and first and second side surfaces, and wherein said pocket or flap is defined at the top surface, at the bottom surface, at least one of the side surfaces or a combination thereof.

18. A system according to claim 16, wherein said pocket or flap is adapted to capture loose materials.

19. A system according to claim 16, wherein said pocket or flap is fabricated from a non-dry erase material.

20. A notebook, comprising:
(a) at least one cover, and
(b) an insert mounted with respect to said cover, said insert including at least one dry erase surface.

21. A notebook according to claim 20, wherein said insert is mounted with respect to a window formed in said at least one cover.

22. A notebook according to claim 20, wherein said notebook takes the form of a three-ring binder.

23. A notebook according to claim 20, wherein said notebook takes the form of a spiral notebook.
